(19) United States
(12) Patent Application Publication
(10) Pub. No.: US 2015/0326143 A1
(43) Pub. Date: Nov. 12, 2015

(54) Synchronous Rectifier Design for Wireless Power Receiver

(71) Applicant: Energous Corporation, Pleasanton, CA (US)

(72) Inventors: Jason Petras, Brentwood, CA (US); Michael Leabman, San Ramon, CA (US)

(73) Assignee: Energous Corporation, Pleasanton, CA (US)

(21) Appl. No.: 14/272,247

(22) Filed: May 7, 2014

(51) Int. Cl. H02M 7/25

(52) U.S. Cl. CPC H02M 7/25

(57) ABSTRACT

Synchronous rectifier circuit topologies for a wireless power receiver receiving a supply of power from a wireless transmitter are disclosed. The synchronous rectifier circuit topologies include a half-bridge diode-FET transistor rectifier for rectifying the wireless power into power including a DC waveform, using a control scheme that may be provided by a delay-locked loop clock, or phase shifters, or wavelength links to control conduction of FET transistors in the synchronous rectifier circuit topology, and maintaining a constant switching frequency to have the diodes, coupled to FET transistors, to allow current to flow through each one respectively at the appropriate timing, focusing on high conduction times. The synchronous rectifier circuit topologies may enable power transfer of high-frequency signals at enhanced efficiency due to significant reduction of forward voltage drop and lossless switching.

### CROSS-REFERENCE TO RELATED APPLICATIONS

The present disclosure is related to U.S. non-provisional patent application DWV-3DPF-010 entitled “Methodology for Pocket-forming”; DWV-3DPF-015 entitled “Method for 3 Dimensional Pocket-forming”; DWV-3DPF-027 entitled “Receivers for Wireless Power Transmission”; DWV-3DPF-029 entitled “Transmitters for Wireless Power Transmission” invented by Michael A. Leabman; and ENG-SYHW-001 entitled “Enhanced Receiver for Wireless Power Transmission” invented by Jason Petras and Michael A. Leabman, each of which is incorporated herein in its entirety.

### BACKGROUND

1. Field of the Disclosure

This disclosure relates generally to wireless power transmission, and more particularly to a half-bridge synchronous rectifier design using circuit topologies with low power loss characteristics for a wireless power receiver.

2. Background Information

A plurality of electronic devices are powered via rechargeable batteries. Such devices include smartphones, portable gaming devices, tablet computers, portable music players, laptop computers, computer peripheral devices, communication devices (e.g., Bluetooth devices), digital cameras, and hearing aids, amongst others. While battery technology has improved, battery-powered electronic devices increasingly require and consume greater amounts of power, thereby often requiring recharging. Rechargeable devices are often charged via wired connections through cables or other similar connectors that are physically connected to a power supply.

Wireless charging technology has been developed and used for electronic devices in an effort to solve problems presented by wired charging solutions, such as contamination of contact terminals and moisture preventing the appropriate charging of the battery in the electronic device. Wireless charging systems may be capable of transferring power in free space and provide power to electronic devices or can be used to charge rechargeable electronic devices. Wireless power transmission is performed through a transmitter and a receiver coupled to the electronic device to be charged. The receive antenna collects the radiated power from the transmitter and rectifies it for charging the battery.

Power converters are used to interface between power sources and electronic devices. Because alternating current is preferred for efficient power transmission, power sources typically provide power at alternating current. On the other hand the operation of many electronic devices requires direct current. In order to provide direct current for such devices from alternating current, the power sources, power converters need to convert the current supplied from alternating to direct, and use rectifiers for this purpose.

Half-bridge rectifiers are commonly used in power converters to provide half-wave rectification of alternating current. A typical half-bridge rectifier include two diodes which are inherently inefficient conductors producing a number of well-known problems. One problem resulting from the inefficiency of diodes is that they produce a forward voltage drop. This is most noticeable in low-voltage power converters where the voltage drop may be a significant proportion of the desired voltage output. Schottky diodes, which exhibit very low voltage drops, are often used to minimize the problem, but are an expensive solution. Conventional half-wave bridge rectifiers utilize junction diodes which show a forward bias voltage drop of approximately 0.7V. Thus, for a half-wave bridge rectifier, the resulting voltage drop relative to the input voltage can be as high as 1.4 volts. Another problem results from the heat dissipated by diodes, particularly in high frequency switching power supplies. Apart from reducing overall efficiency of the power converter, resulting high temperatures also reduce the reliability of components. Thus, additional design effort may be required to overcome the problems, and other factors such as the dimensions of the system may be affected as a result.

As such, there is a need for synchronous rectifiers characterized by low power loss characteristics and low associated heat loss for wireless power transfer systems that efficiently and safely transfer power at varying power levels to increase power transmission efficiency to electronic devices.

### SUMMARY

According to embodiments, it is an object of the present disclosure to provide synchronous rectifier (SR) circuit topologies designed for wireless power transmission receivers of a plurality of system configuration and power transfer control schemes. The design of SR circuit topologies of present disclosure may include a plurality of switching control schemes for power conversion where the voltage output from a wireless transmitter is received by a wireless receiver antenna array and may be transferred output voltage for other modules in the wireless receiver when the SR is conductive.

The plurality of SR circuit topologies may be designed to be low cost, complexity and size, in which diode conduction may be limited and capable of operating at high switching frequencies to reduce reverse recovery losses and voltage stresses, enabling low power loss characteristics of the disclosed SR circuit topologies.

Since the voltage drop across a controlled rectifier is smaller than the voltage drop across an uncontrolled rectifier, the output voltage may undergo a transient if the controlled rectifier is suddenly enabled. To avoid the transient, the controlled rectifiers may be turned on with a slowly changing average on-state voltage during a conduction time that may be a portion of the overall switching cycle. In order to accomplish these and other objects of the present disclosure, the plurality of switching control schemes may include methods of controlling the synchronous rectifier with switching FET transistors which may control conduction of the synchronous rectifier in accordance with the level of voltage and frequency that may be detected at the input terminals, providing phase-shifted signals for the FET transistors to allow conduction and transfer of the converted power with a significant reduction of forward voltage drop and power losses.

Accordingly, in an embodiment, a control-driven synchronous rectifier circuit topology may be enabled using a delay-locked loop (DLL) clock to control switching of FET transistors in the synchronous rectifier and to provide a practically lossless switching and reduced forward voltage drop improving efficiency of power transfer. In this embodiment, conduction control of synchronous rectification may be enabled for a plurality of high-frequency signals received from a wireless transmitter including a level of high-frequency signals which may be within the 900 MHz, 2.4 GHz, and 5.7 GHz unlicensed bands. The task of implementing control-driven SR may require accurate timing adjustment algorithms that can be designed discretely, but are much simpler when integrated into an integrated circuit solution, such as a delay-locked loop.

In an another aspect of present disclosure a synchronous rectifier circuit topology may be enabled using phase shifters to provide a significantly less loss switching and reduced forward voltage drop improving efficiency of power transfer. In this synchronous rectifier circuit topology, FET transistors may be driven by gate-drive signals derived from the phase shifters for conduction control of synchronous rectification of a plurality of high-frequency signals received from wireless transmitter. In present embodiment, the level of high-frequency signals may be within the 900 MHz, 2.4 GHz, and 5.7 GHz unlicensed bands.

In yet another aspect, present disclosure may include a synchronous rectifier circuit topology using a switching control scheme provided by wavelength links, which may be added as a frequency-division demultiplexing of the signal received by the antenna element of a wireless power receiver from a wireless transmitter. Wavelength links may be of different wavelength spacing in order to have the required phase shifting to enable switching control of FET transistors and to provide the proper timing for current to flow through diodes coupled to FET transistors. The focus on high conduction times per switching control scheme required provides a significantly less loss switching and reduced forward voltage drop improving efficiency of power transfer.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 illustrates wireless power transmission using pocket forming, according to an embodiment.

FIG. 2 depicts a block diagram of a transmitter, which may be used for wireless power transmission systems, according to an embodiment.

FIG. 3 shows a block diagram of a receiver which can be used for wireless powering or charging one or more electronic devices, according to an embodiment.

FIG. 4 represents a circuit diagram of a half-bridge diode rectifier of the prior art, according to an embodiment.

FIG. 5 illustrates a circuit diagram of a synchronous rectifier including a half-bridge diode-FET transistor rectifier and a delayed-lock loop clock for conduction control, according to an embodiment.

FIG. 6 corresponds to a graph of waveforms depicting input voltage received, gate drive control signal and output voltage during conduction times of a synchronous rectifier, according to an embodiment.

FIG. 7 depicts a circuit diagram of a synchronous rectifier including a half-bridge diode-FET transistor rectifier and phase shifters for conduction control, according to an embodiment.

FIG. 8 shows a circuit diagram of a synchronous rectifier including a half-bridge diode-FET transistor rectifier and phase shifted wavelength lines for conduction control, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Wireless device” refers to any electronic device able to communicate using one or more suitable wireless technologies. Suitable devices may include client devices in wireless networks and may be part of one or more suitable wireless technologies, including Wi-Fi and Bluetooth amongst others.

“Wireless transmitter” refers to a device, including a chip which may generate two or more RF signals, at least one RF signal being phase shifted and gain adjusted with respect to other RF signals substantially, all of which pass through one or more RF antenna such that focused RF signals are directed to a target.

“Wireless receiver” refers to a device including at least one antenna element, at least one rectifying circuit and at least one power converter, which may utilize pockets of energy for powering, or charging a wireless device.

“Pocket-forming” may refer to generating two or more RF waves which converge in 3-d space, forming controlled constructive and destructive interference patterns.

“Adaptive pocket-forming” may refer to dynamically adjusting pocket-forming to regulate power on one or more targeted receivers.

“Synchronous rectifier” refers to a power transmission circuit including active rectifiers controlled by switches such as transistors for improving the efficiency of rectification. The control circuitry for active rectification usually uses sensors for the voltage of the input AC to open the transistors at the correct times to allow current to flow in the correct direction.

“FET transistor” refers to a switch used to open or close an analog or digital circuit.

“Delay-locked loop clock” refers to a digital circuit used to change the phase of a clock signal with a periodic waveform to enhance timing characteristics of integrated circuits.

### DESCRIPTION OF THE DRAWINGS

The present disclosure may provide synchronous rectifier (SR) circuit topologies designed for wireless power transmission receivers of a plurality of system configuration and power transfer control schemes. The design of SR circuit topologies of present disclosure may include a plurality of switching control schemes for power conversion where the voltage output from a wireless transmitter is received by a wireless receiver antenna array and may be transferred output voltage for other modules in the wireless receiver when the SR is conductive.

Wireless Power Transmission System Hardware Configuration

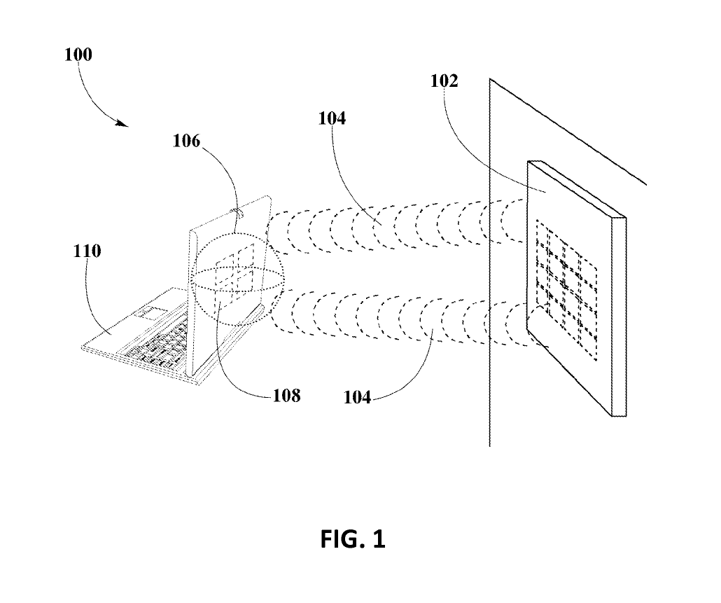

FIG. 1 illustrates a wireless power transmission 100 using pocket-forming. A transmitter 102 may transmit controlled Radio Frequency (RF) waves 104 which may converge in 3-d space. These RF waves 104 may be controlled through phase and/or relative amplitude adjustments to form constructive and destructive interference patterns (pocket-forming). Pockets of energy 106 may be formed at constructive interference patterns and can be 3-dimensional in shape, while null-spaces may be generated at destructive interference patterns. A receiver 108 may then utilize pockets of energy 106 produced by pocket-forming for charging or powering a cordless electronic device 110, for example, a smartphone, a tablet, a laptop computer (as shown in FIG. 1), a music player, an electronic toy, and the like. In some embodiments, there can be multiple transmitters 102 and/or multiple receivers 108 for powering various electronic devices 110 at the same time. In other embodiments, adaptive pocket-forming may be used to regulate the power transmitted to electronic devices 110.

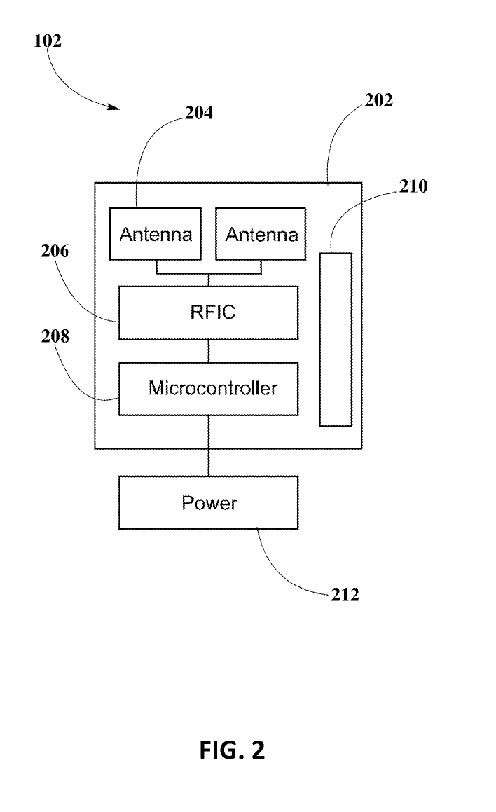

FIG. 2 depicts the block diagram of transmitter 102 which may be used in wireless power transmission 100. Transmitter 102 may include a housing 202, at least two or more antenna elements 204, at least one RF integrated circuit (RFIC) 206, at least one digital signal processor (DSP) or micro-controller 208, and one communications component 210. Housing 202 can be made of any suitable material which may allow for signal or wave transmission and/or reception, for example plastic or hard rubber. Antenna elements 204 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 204 may include vertical or horizontal polarization, right hand or left hand polarization, elliptical polarization, or other suitable polarizations as well as suitable polarization combinations. Suitable antenna types may include, for example, patch antennas with heights from about ⅛ of an inch to about 8 inches and widths from about ⅛ of an inch to about 6 inches. Other antenna elements 204 types that may be used include meta-materials based antennas, dipole antennas, and planar inverted-F antennas (PIFAs), amongst others.

RFIC 206 may include a proprietary chip for adjusting phases and/or relative magnitudes of RF signals which may serve as inputs for antenna elements 204 for controlling pocket-forming. These RF signals may be produced using a power source 212 and a local oscillator chip (not shown) using a suitable piezoelectric material. Micro-controller 208 may then process information sent by receiver 108 through communications component 210 for determining optimum times and locations for pocket-forming. Communications component 210 may be based on standard wireless communication protocols which may include Bluetooth, Wi-Fi or ZigBee. In addition, communications component 210 may be used to transfer other information, such as an identifier for the device or user, battery level, location, or other such information. Other communications component 210 may be possible, including radar, infrared cameras or sound devices for sonic triangulation of electronic device 110 position.

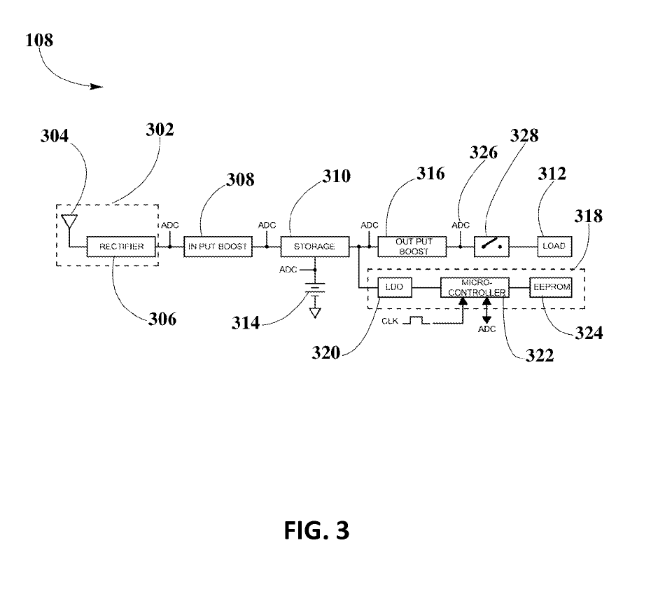

FIG. 3 shows a block diagram of receiver 108 which can be used for wireless powering or charging one or more electronic devices 110 as exemplified in wireless power transmission 100. According to some aspects of this embodiment, receiver 108 may operate with the variable power source generated from transmitted RF waves 104 to deliver constant and stable power or energy to electronic device 110. In addition, receiver 108 may use the variable power source generated from RF waves 104 to power up electronic components within receiver 108 for proper operation.

Receiver 108 may be integrated in electronic device 110 and may include a housing (not shown in FIG. 3) that can be made of any suitable material to allow for signal or wave transmission and/or reception, for example plastic or hard rubber. This housing may be an external hardware that may be added to different electronic equipment, for example in the form of cases, or can be embedded within electronic equipment as well.

Receiver 108 may include an antenna array 302 which may convert RF waves 104 or pockets of energy 106 into electrical power. Antenna array 302 may include one or more antenna elements 304 operatively coupled with one or more rectifiers 306. RF waves 104 may exhibit a sinusoidal shape within a voltage amplitude and power range that may depend on characteristics of transmitter 102 and the environment of transmission. The environment of transmission may be affected by changes to or movement of objects within the physical boundaries, or movement of the boundaries themselves. It is also affected by changes to the medium of transmission; for example, changes to air temperature or humidity. As a result, the voltage or power generated by antenna array 302 may be variable. As an illustrative embodiment, and not by way of limitation, the alternating current (AC) voltage or power generated by antenna element 304 from transmitted RF waves 104 or pocket of energy 106 may vary from about 0 volts or 0 watt to about 5 volts at 3 watts.

Antenna element 304 may include suitable antenna types for operating in frequency bands similar to the bands described for transmitter 102 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example electronic device 110. On the contrary, for devices with well-defined orientations, for example a two-handed video game controller, there might be a preferred polarization for antennas which may dictate a ratio for the number of antennas of a given polarization. Suitable antenna types may include patch antennas with heights from about ⅛ inches to about 6 inches and widths from about ⅛ inches to about 6 inches. Patch antennas may have the advantage that polarization may depend on connectivity, i.e. depending on which side the patch is fed, the polarization may change. This may further prove advantageous as receiver 108 may dynamically modify its antenna polarization to optimize wireless power transmission 100.

Rectifier 306 may include diodes or resistors, inductors or capacitors to rectify the AC voltage generated by antenna element 304 to direct current (DC) voltage. Rectifier 306 may be placed as close as is technically possible to antenna element 304 to minimize losses. In one embodiment, rectifier 306 may operate in synchronous mode, in which case rectifier 306 may include switching elements that may improve the efficiency of rectification. As an illustrative embodiment, and not by way of limitation, output of rectifier 306 may vary from about 0 volts to about 5 volts.

An input boost converter 308 can be included in receiver 108 to convert the variable DC output voltage of rectifier 306 into a more stable DC voltage that can be used by components of receiver 108 and/or electronic device 110. Input boost converter 308 may operate as a step-up DC-to-DC converter to increase the voltage from rectifier 306 to a voltage level suitable for proper operation of receiver 108. As an illustrative embodiment, and not by way of limitation, input boost converter 308 may operate with input voltages of at least 0.4 volts to about 5 volts to produce an output voltage of about 5 volts. In addition, input boost converter 308 may reduce or eliminate rail-to-rail deviations. In one embodiment, input boost converter 308 may exhibit a synchronous topology to increase power conversion efficiency.

As the voltage or power generated from RF waves 104 may be zero at some instants of wireless power transmission 100, receiver 108 can include a storage element 310 to store energy or electric charge from the output voltage produced by input boost converter 308. In this way, storage element 310, through an output boost converter 316, may deliver continuous voltage or power to a load 312, where this load 312 may represent the battery or internal circuitry of electronic device 110 requiring continuous powering or charging. For example, load 312 may be the battery of a mobile phone requiring constant delivery of 5 volts at 2.5 watts.

Storage element 310 may include a battery 314 to store power or electric charge from the voltage received from input boost converter 308. Battery 314 may be of different types, including but not limited to, alkaline, nickel-cadmium (NiCd), nickel-metal hydride (NiHM), and lithium-ion, among others. Battery 314 may exhibit shapes and dimensions suitable for fitting receiver 108, while charging capacity and cell design of battery 314 may depend on load 312 requirements. For example, for charging or powering a mobile phone, battery 314 may deliver a voltage from about 3 volts to about 4.2 volts.

In another embodiment, storage element 310 may include a capacitor (not shown in FIG. 3) instead of battery 314 for storing and delivering electrical charge as required by the receiver. As a way of example, in the case of charging or powering a mobile phone, receiver 108 may include a capacitor with operational parameters matching the load device's power requirements.

Receiver 108 may also include output boost converter 316 operatively coupled with storage element 310 and input boost converter 308, where this output boost converter 316 may be used for matching impedance and power requirements of load 312. As an illustrative embodiment, and not by way of limitation, output boost converter 316 may increase the output voltage of battery 314 from about 3 or 4.2 volts to about 5 volts which may be the voltage required by the battery or internal circuitry of electronic device 110. Similarly to input boost converter 308, output boost converter 316 may be based on a synchronous topology for enhancing power conversion efficiency.

Storage element 310 may provide power or voltage to a communication subsystem 318 which may include a low-dropout regulator (LDO 320), a main system micro-controller 322, and an electrically erasable programmable read-only memory (EEPROM 324). LDO 320 may function as a DC linear voltage regulator to provide a steady voltage suitable for low energy applications as in main system micro-controller 322. Main system micro-controller 322 may be operatively coupled with EEPROM 324 to store data for the operation and monitoring of receiver 108. Main system micro-controller 322 may also include a clock (CLK) input and general purpose inputs/outputs (GPIOs).

In one embodiment, main system micro-controller 322 in conjunction with EEPROM 324 may run an algorithm for controlling the operation of input boost converter 308 and output boost converter 316 according to load 312 requirements. Main system micro-controller 322 may actively monitor the overall operation of receiver 108 by taking one or more power measurements 326 (ADC) at different nodes or sections as shown in FIG. 3. For example, micro-controller 322 may measure how much voltage or power is being delivered at rectifier 306, input boost converter 308, battery 314, output boost converter 316, communication subsystem 318, and/or load 312. Main system micro-controller 322 may communicate these power measurements 326 to load 312 so that electronic device 110 may know how much power it can pull from receiver 108. In another embodiment, main system micro-controller 322, based on power measurements 326, may control the power or voltage delivered at load 312 by adjusting the load current limits at output boost converter 316. Yet in another embodiment, a maximum power point tracking (MPPT) algorithm may be executed by main system micro-controller 322 to control and optimize the amount of power that input boost converter 308 can pull from antenna array 302.

In another embodiment, main system micro-controller 322 may regulate how power or energy can be drained from storage element 310 based on the monitoring of power measurements 326. For example, if the power or voltage at input boost converter 308 runs too low, then micro-controller 322 may direct output boost converter 316 to drain battery 314 for powering load 312.

Receiver 108 may include a switch 328 for resuming or interrupting power being delivered at load 312. In one embodiment, micro-controller 322 may control the operation of switch 328 according to terms of services contracted by one or more users of wireless power transmission 100 or according to administrator policies.

Half-Bridge Diode Rectifier of the Prior Art

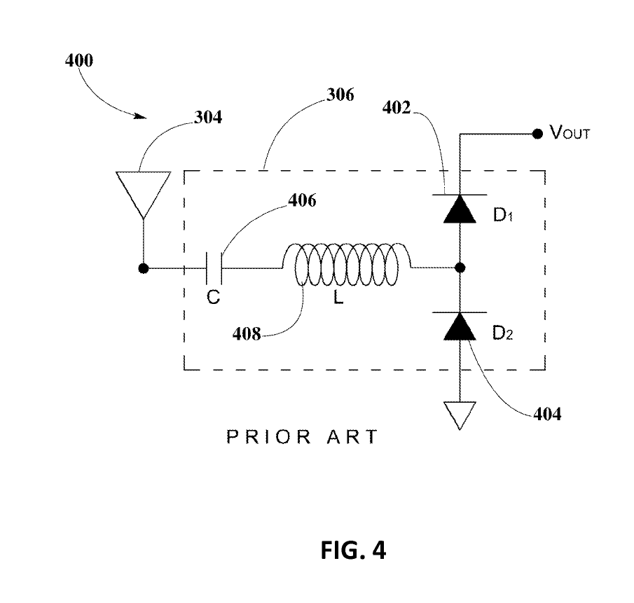

FIG. 4 represents a circuit diagram 400 of a half-bridge diode rectifier 306 of the prior art, according to embodiment shown in FIG. 3 as antenna array 302, including antenna element 304.

When an alternating RF signal is received from wireless transmitter 102, a direct voltage output V_{OUT} may be drawn from the output terminals of the half-bridge diode rectifier 306.

Two diodes, D₁ and D₂, respectively identified as diode 402 and diode 404 are wired in series upstream and connected to output terminal. Antenna element 304 is connected in series to capacitor 406, which is connected in series to inductor 408, both acting as the resonant filter for the power signal being transferred from wireless transmitter 102 and received by antenna element 304 of wireless power receiver 108.

When the polarity of the alternating RF signal received may be positive, current flows through the first upstream diode D₁ and when the polarity of the alternating RF signal received is negative, current flows through second upstream diode D₂.

Half-bridge diode rectifiers, such as that shown in FIG. 4, may be used to produce an output with a fixed polarity that is independent of the polarity of the input. Half-bridge diode rectifiers may be used in AC-to-DC power converters, for example. Optionally, the output may be smoothed by a smoothing capacitor (not shown).

It may be noticed that as output voltages drop, the diode's forward voltage is more significant and may reduce conversion efficiency. Physical limitations prevent the forward voltage drop of diodes 402, 404 from being reduced to a level of voltage drop that may be less than about 0.3 V. Additionally, power is lost from each diode 402, 404 with each reversal of polarity. In high frequency power converters, where the polarity of the input signal may oscillate at frequencies of 100 kHz or more, such power losses may result in significant heating of the rectifier circuit and other components surrounding the rectifier. This situation may result in reduced reliability or failure of the rectifier circuit.

Control-Driven Synchronous Rectifier Circuit Topology

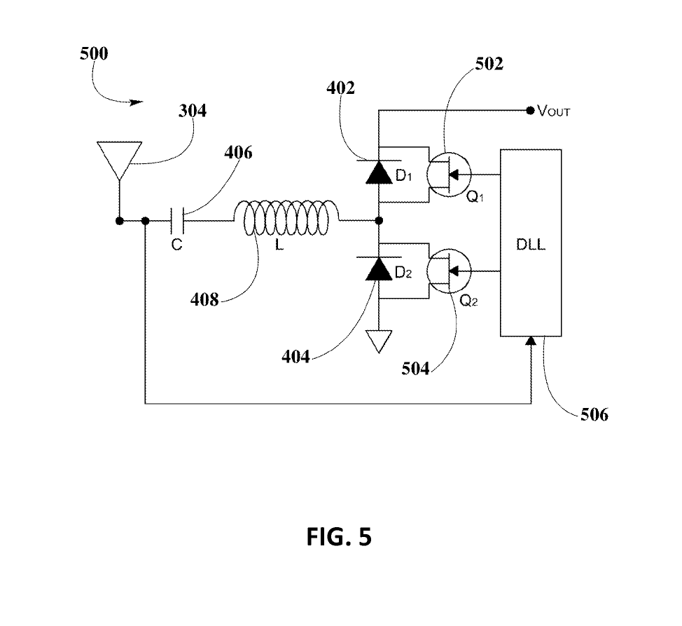

FIG. 5 illustrates a circuit diagram 500 of synchronous rectifier 306 for wireless power receiver 108, connected to antenna element 304 and resonant filter including capacitor 406 and inductor 408, according to an embodiment. In this circuit, synchronous rectification may be enabled by a half-bridge rectifier configuration using diode 402 coupled to FET transistor 502 (CU) and diode 404 coupled to FET transistor 504. This half-bridge rectifier configuration using synchronous rectification with coupled diode 402 and FET transistor 502, and coupled diode 404 and FET transistor 504 may be used to improve the efficiency limit which may result from using a half-bridge diode rectifier of prior art. As power conversion efficiency is primarily a function of the output voltage, output current, and the on-resistance and forward voltage drop of diodes 402, 404, adding FET transistors 502, 504 may provide significant improvement in power transfer from wireless transmitter 102 to wireless power receiver 108. Replacing a half-bridge diode rectifier of prior art with a synchronous rectifier 306 depicted in circuit diagram 500 may introduce a synchronous rectifier possessing almost linear resistance characteristics and a lower forward-voltage drop. Consequently, the rectifier conduction loss may be reduced.

In this synchronous rectifier circuit topology, FET transistors 502, 504 may be driven by gate-drive signals derived from delayed-lock loop (DLL) clock 506 for conduction control of synchronous rectification of a plurality of high-frequency signals received from wireless transmitter 102. In present embodiment, the level of high-frequency signals may be within the 900 MHz, 2.4 GHz, and 5.7 GHz unlicensed bands.

Conduction times which may result by driving the half-bridge synchronous rectifiers from DLL clock 506 may reach a maximum conduction time of FET transistor 502 because it has no effect of the conduction time of current through diode 404 during dead time given that during dead time FET transistor 504 is in off state.

DLL clock 506 may be used to change the phase of the clock signal controlling FET transistors 502, 504 with a delay chain of delay gate signals which may be phase-locked depending on the frequency of the signal received by antenna element 304.

The precise gate-drive timing provided by DLL clock 506 may allow that when conduction through diode 402 may be applied or terminated, at the same instant conduction through diode 404 may be terminated or applied.

Circuit diagram 500 may be modified using a separate antenna element (not shown in FIG. 5) which is not included in antenna array 302. A modified synchronous rectifier circuit topology may be implemented by having DLL clock 506 directly connected to this second antenna element rather than deriving the control signal from the first antenna element 304 as shown in FIG. 5. The use of a separate antenna element connected to DLL clock 506 may prevent increasing the input impedance from antenna element 304 thus causing a reduction in the efficiency of the synchronous rectifier 306.

Switching Control Scheme

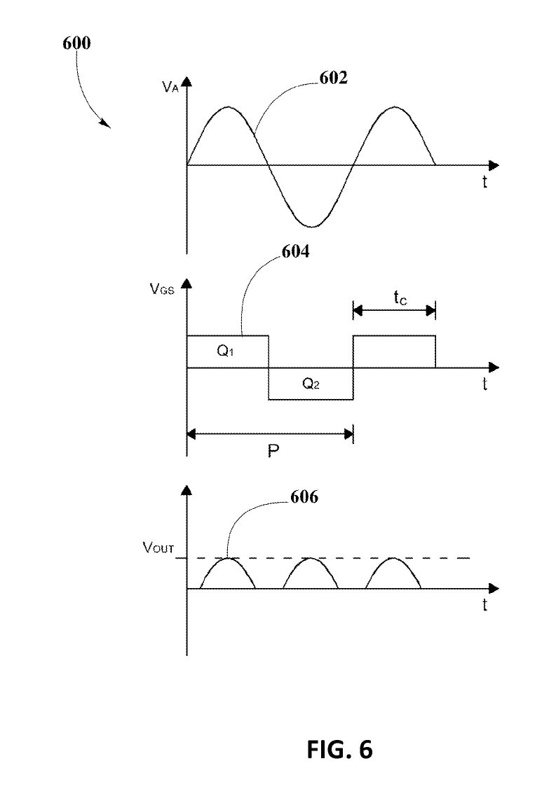

FIG. 6 corresponds to a graph of waveforms 600 depicting voltage received and conduction times of synchronous rectifier 306, for wireless power receiver 108 described in FIG. 3.

In FIG. 6, waveform 602 may represent the input voltage (V_{A}) received by antenna element 304; waveform 604 may illustrate the voltage of gate signals (V_{GS}) respectively applied to FET transistor 502, 504 to control conduction; and waveform 606 may show the output voltage (V_{OUT}) at the terminals of synchronous rectifier 306.

The gate-drive timing of SRs may not allow conduction of diodes 402, 404 of synchronous rectifier 306 except for the unavoidable conduction of diode 404 during the dead time. This may only be possible with a very precise gate-drive timing where the gate-drive for FET transistor 502 may be applied or terminated at the same instant the gate-drive of FET transistor 504 may be terminated or applied. In practical applications, any accidental, brief overlapping of the gate-drive signals that turn on both SRs simultaneously may cause a short-circuit which may lower efficiency or, in severe cases, may cause the synchronous rectifier failure. To avoid simultaneous conduction of SRs in practical applications, a delay between the gate-drive signals may be introduced. Since during the delay period no gate-drive signal is applied to the SRs, the diodes 402, 404 of the SRs are conducting. This not only increases conduction loss but also introduces reverse-recovery loss. Therefore, the performance of control-driven SRs is strongly dependent on the timing of the gate drive that may be enabled using DLL clock 506 as seen in circuit diagram 500. This may be seen in waveform 604 for which a positive gate signal (+V_{GS}) may be applied from DLL clock 506 to FET transistor 502 for a conduction time, t_{C}, during which FET transistor 504 is on off state. During FET transistor 502 conduction time, losses due to voltage drop may be practically the voltage drop losses of FET transistor 502, which are much lower than the voltage drop losses of diode 402, thus allowing only current to flow through diode 402 during the high conduction time. Similarly, since input voltage V_{A} is from a monotonic power source, DLL clock 506 have to phase shift current to turn on FET transistor 504 at appropriate time once there is no current through diode 402, then allowing current to flow through diode 404 with a minimum level of voltage drop losses, which are mainly related to the voltage drop losses of FET transistor 504, during the high conduction time during the negative voltage of gate signal (−V_{GS}).

As seen in waveform 606, the switching control that may be provided by DLL clock 506 may result in a more significant level of power transfer to the other components in wireless power receiver 108. Waveform 606, when DLL clock 506 is operating, has a focus on high conduction time.

As seen, both SR gate drives may be regulated and, therefore, independent of input voltage variations or incoming power variations, so switching transitions remain constant over line and load. Since the output is controlled by the DLL clock 506, decisions may be made regarding when to turn off the SRs based on load current or output voltage. Optimizing proper SR gate drive timing in implementing control-driven SR often may require more accurate timing adjustment algorithms that can be designed discretely, but are much simpler when integrated into an integrated circuit solution, such as a DLL clock 506.

Synchronous Rectifier Circuit Topology Including Phase Shifters

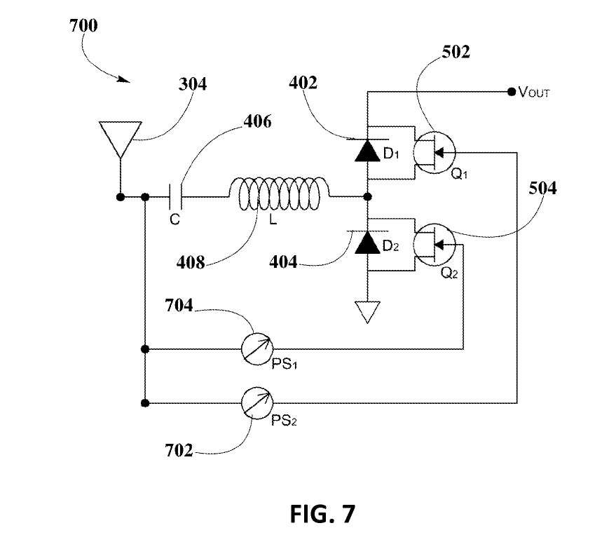

FIG. 7 depicts a circuit diagram 700 of synchronous rectifier 306 for wireless power receiver 108, connected to antenna element 304 and resonant filter including capacitor 406 and inductor 408, according to an embodiment. In this circuit, synchronous rectification may be enabled by a half-bridge rectifier configuration using diode 402 coupled to FET transistor 502 (CU) and diode 404 coupled to FET transistor 504. This half-bridge rectifier configuration using synchronous rectification with coupled diode 402 and FET transistor 502, and coupled diode 404 and FET transistor 504 may be used to improve the efficiency limit which may result from using a half-bridge diode rectifier of prior art. As power conversion efficiency is primarily a function of the output voltage, output current, and the on-resistance and forward voltage drop of diodes 402, 404, adding FET transistors 502, 504 may provide significant improvement in power transfer from wireless transmitter 102 to wireless power receiver 108. Replacing a half-bridge diode rectifier of prior art with a synchronous rectifier 306 depicted in circuit diagram 700 may introduce a synchronous rectifier possessing almost linear resistance characteristics and a lower forward-voltage drop. Consequently, the rectifier conduction loss may be reduced.

In this synchronous rectifier circuit topology, FET transistors 502, 504 may be driven by gate-drive signals derived from phase shifters 702, 704 for conduction control of synchronous rectification of a plurality of high-frequency signals received from wireless transmitter 102. In present embodiment, the level of high-frequency signals may be within the 900 MHz, 2.4 GHz, and 5.7 GHz unlicensed bands.

Phase shifters 702, 704 may be used to change the phase of the gate signal controlling FET transistors 502, 504 which may be phase-locked depending on the frequency of the signal received by antenna element 304.

The accurate gate-drive timing provided by phase shifters 702, 704 may allow that when conduction through diode 402 may be applied or terminated, at the same instant conduction through diode 404 may be terminated or applied.

Switching controlling for a phase-shifted synchronous rectifier 306 may start by developing two gate signal drives with a method of varying the phase relationship between them from 90° to 180°. Each gate signal drive from phase shifters 702, 704 may have an output which alternate with a 50% duty cycle to alternately drive FET transistor 502, 504. As the frequency of the incoming signal may change phase shifters 702, 704 may adapt to maintain the same level of current passing through diode 402 and diode 404, respectively, maintaining focus on high conduction times per switching control scheme previously described in FIG. 6, so that they run at constant frequency and the phase relationship between the two complimentary gate signal may enable that both FET transistors 502, 504 may turn on and off with zero voltage across them, resulting in close to lossless switching when proper timing may be provided.

Therefore, the performance of SRs driven by phase shifters 702, 704 is strongly dependent on the timing of the gate drive signals that may be enabled, as seen in circuit diagram 700. This may be seen in waveform 604 for which a positive gate signal (+V_{GS}) may be applied from phase shifter 702 to FET transistor 502 for a conduction time, t_{C}, during which FET transistor 504 is on off state. During FET transistor 502 conduction time, losses due to voltage drop may be practically the voltage drop losses of FET transistor 502, which are much lower than the voltage drop losses of diode 402, thus allowing only current to flow through diode 402 during the high conduction time. Similarly, since input voltage V_{A} is from a monotonic power source, phase shifter 704 have to phase shift current to turn on FET transistor 504 at appropriate time once there is no current through diode 402, then allowing current to flow through diode 404 with a minimum level of voltage drop losses, which are mainly related to the voltage drop losses of FET transistor 504, during the high conduction time during the negative voltage of gate signal (−V_{GS}).

Synchronous Rectifier Circuit Topology Including Wavelength Links

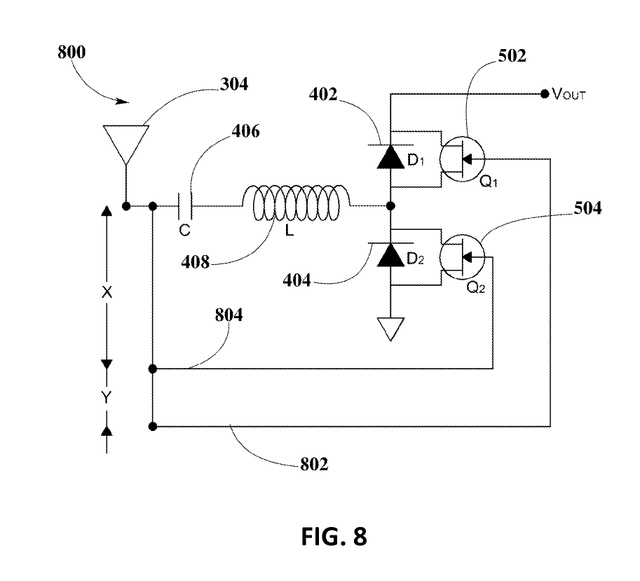

FIG. 8 depicts a circuit diagram 800 of synchronous rectifier 306 for wireless power receiver 108, connected to antenna element 304 and resonant filter including capacitor 406 and inductor 408. In this circuit, synchronous rectification may be enabled by a half-bridge rectifier configuration using diode 402 coupled to FET transistor 502 (Q1) and diode 404 coupled to FET transistor 504. This half-bridge rectifier configuration using synchronous rectification with coupled diode 402 and FET transistor 502, and coupled diode 404 and FET transistor 504 may be used to improve the efficiency limit which may result from using a half-bridge diode rectifier of prior art. As power conversion efficiency is primarily a function of the output voltage, output current, and the on-resistance and forward voltage drop of diodes 402, 404, adding FET transistors 502, 504 may provide significant improvement in power transfer from wireless transmitter 102 to wireless power receiver 108. Replacing a half-bridge diode rectifier of prior art with a synchronous rectifier 306 depicted in circuit diagram 800 may introduce a synchronous rectifier possessing almost linear resistance characteristics and a lower forward-voltage drop. Consequently, the rectifier conduction loss may be reduced.

In this synchronous rectifier circuit topology, FET transistors 502, 504 may be driven by gate-drive signals derived from wavelength links 802, 804 for conduction control of synchronous rectification of a plurality of high-frequency signals received from wireless transmitter 102. In present embodiment, the level of high-frequency signals may be within the 900 MHz, 2.4 GHz, and 5.7 GHz unlicensed bands.

Wavelength links 802, 804 may be added as a frequency-division demultiplexing of the signal received by antenna element 304 from wireless transmitter 102. Wavelength links 802, 804 may be of different wavelength spacing in order to have the required phase shifting to enable switching control of FET transistor 502, 504 and providing the proper timing for current to flow through diodes 402, 404 focusing on high conduction times per switching control scheme previously described in FIG. 6, so that they run at constant frequency and the phase relationship between the two gate signals may enable that both FET transistors 502, 504 may turn on and off with zero voltage across them, resulting in close to lossless switching. Wavelength links 802, 804 may use spacing X and Y as shown in FIG. 8 within a range of about ¼ λ to ½ λ at about 5.7 GHz.

Therefore, the performance of SRs driven by wavelength links 802, 804 is strongly dependent on the timing of the gate drive signals that may be enabled, as seen in circuit diagram 800. This may be seen in waveform 604 for which a positive gate signal (+V_{GS}) may be applied from wavelength link 802 to FET transistor 502 for a conduction time, t_{C}, during which FET transistor 504 is on off state. During FET transistor 502 conduction time, losses due to voltage drop may be practically the voltage drop losses of FET transistor 502, which are much lower than the voltage drop losses of diode 402, thus allowing only current to flow through diode 402 during the high conduction time. Similarly, since input voltage V_{A} is from a monotonic power source, wavelength link 804 have to phase shift current to turn on FET transistor 504 at appropriate time once there is no current through diode 402, then allowing current to flow through diode 404 with a minimum level of voltage drop losses, which are mainly related to the voltage drop losses of FET transistor 504, during the high conduction time during the negative voltage of gate signal (−V_{GS}).

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A wireless power receiver comprising:
an antenna configured to receive radio frequency (RF) power waves; and
a synchronous rectifier configured to synchronously rectify an AC voltage of the RF power waves to create a DC voltage for powering a device coupled to the wireless power receiver.

2. The receiver of claim 1, further comprising two or more switches configured to control conduction of the synchronous rectifier in accordance with a received voltage and frequency of the RF power waves.

3. The receiver of claim 2, wherein the two or more switches comprise two or more field effect (FET) transistors.

4. The receiver of claim 2, further comprising a delay-locked loop configured to control switching of the two or more transistors.

5. The receiver of claim 2, wherein the two or more switches are driven by gate-drive signals derived from one or more phase shifters.

6. The receiver of claim 1, further comprising an input boost converter operatively coupled to the synchronous rectifier, the input boost converter being configured to increase the DC voltage from the synchronous rectifier.

7. The receiver of claim 6, further comprising a storage element configured to store power from the increased DC voltage received from the input boost converter.

8. The receiver of claim 7, further comprising an output booster configured to match an impedance of a load associated with the device.

9. The receiver of claim 8, further comprising a processor configured to control operation of the input booster and the output booster in accordance with the load of the device.

10. The receiver of claim 1, wherein the two or more switches are driven by gate-drive signals derived from one or more wavelength links.

11. A method for receiving wireless power, comprising:
receiving one or more radio frequency (RF) power waves; and
synchronously rectifying the received RF power wave to create a direct current (DC) voltage for powering a device.

12. The method of claim 11, further comprising:
controlling conduction of the synchronous rectification in accordance with a received voltage and frequency of the RF power waves.

13. The method of claim 12, wherein conduction control is driven by gate-drive signals derived from one or more phase shifters.

14. The method of claim 11, further comprising increasing the DC voltage of the one or more RF power waves.

15. The method of claim 14, further comprising storing power from the increased DC voltage.

16. The method of claim 15, further comprising matching an impedance of a load of the device.

17. The method of claim 16, further comprising controlling operation of the increasing and matching in accordance with the load of the device.

18. The method of claim 11, further comprising frequency division multiplexing the received one or more RF power waves to derive gate-driven signals to drive the switching.

19. The method of claim 11, wherein the receiving an RF power wave comprises receiving pockets of energy.

20. The method of claim 11, further comprising phase shifting one of the one or more RF power waves to control the switching.
